(19) United States
(12) Patent Application Publication
(10) Pub. No.: US 2007/0124289 A1
(43) Pub. Date: May 31, 2007

(54) Remote execution of actions transparent to a user at registered remote entities in real-time

(76) Inventor: Tomasz Imielinski, Princeton, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/292,232

(22) Filed: Nov. 30, 2005

(51) Int. Cl. G06F 17/30

(52) U.S. Cl. 707/3

(57) ABSTRACT

An apparatus and a method of remotely executing actions in real-time transparent to a user are described. The method includes an execution engine that receives a natural language executable string from a user, identifies a remote entity capable of executing the natural language executable string, sending the executable string to the remote entity to remotely execute an action using information from the executable string, and receiving a result for the user from the remote entity based on the action.

### BACKGROUND OF THE INVENTION

1. Field of the Invention

The present invention relates to the field of e-commerce and searches on the internet.

2. Discussion of Related Art

Search engines and e-commerce sites are either completely decoupled or tightly integrated in one website. Examples of completely decoupled relationships include Google, Ask.com, msn.com, and Yahoo. In these examples of completely decoupled relationships a search performed by the user provides the user with the URL of an ecommerce site and the user then goes to that website and executes a purchase transaction or a search at that site. When a user is directed to another website the user has to re-enter their search or criteria for the transaction into a form on that website, oftentimes re-entering information that has already been entered on the search website.

Amazon.com is an example of a tightly coupled infrastructure. It has its own search engine and its own e-commerce activities. That is, Amazon is one business entity that operates both the search engine and the e-commerce sites.

There are also pure shopping oriented search engines such as Shopping.com that use a menu driven, category based search rather than a search engine. For example, a user can find all laptops that weigh less than 6 lbs and all laptops that cost less than $1000 and all laptops that have at lest 1 Ghz CPU by browsing through three different categories, but cannot find all laptops with all three parameters with a single search. A user also cannot find the least expensive laptop that meets the given criteria or find the lightest laptop under a given price. The user needs to do a lot of browsing and comparing to find this information.

### SUMMARY OF THE INVENTION

An apparatus and a method of remotely executing actions in real-time transparent to a user are described. The method includes an execution engine that receives a natural language executable string from a user, identifies a remote entity capable of executing the natural language executable string, sending the executable string to the remote entity to remotely execute an action using information from the executable string, and receiving a result for the user from the remote entity based on the action.

### BRIEF DESCRIPTION OF THE DRAWINGS

FIG. 1 is a block diagram of a network-based system utilizing an execution engine.

FIG. 2 is an illustration of an execution engine.

FIG. 3 is a flow diagram of a method of remote execution of actions transparent to a user at registered remote entities in real-time.

FIG. 4A is an interaction diagram for a method where the remote execution of an action is performed transparent to a user and a single result is returned to the user.

FIGS. 4B-4D are screen shots presented to a user in different examples of remote execution of an action performed transparent to a user and a single result returned to the user.

FIG. 5A is an interaction diagram where the response returned to a user after the remote execution of an action is a query and a result.

FIGS. 5B are screen shots presented to a user when the result is a query and a result.

FIG. 6A is an interaction diagram where the result presented to the user are results from more than one remote entity.

FIGS. 6B-6D are screen shots illustrating examples of the interaction diagram of FIG. 6A.

FIG. 7A is an interaction diagram where the remotely executed action is a complex action.

FIG. 7B is a screen shot illustrating an example of the interaction diagram of FIG. 7A.

FIG. 8A is an interaction diagram where the remotely executed action is a search on a remote entity.

FIG. 8B is a screen shot illustrating an example of the interaction diagram of FIG. 8A.

### DETAILED DESCRIPTION

In the following description numerous specific details are set forth in order to provide a thorough understanding of the present invention. One of ordinary skill in the art will understand that these specific details are for illustrative purposes only and are not intended to limit the scope of the present invention. Additionally, in other instances, well-known processing techniques and equipment have not been set forth in particular detail in order to not unnecessarily obscure the present invention.

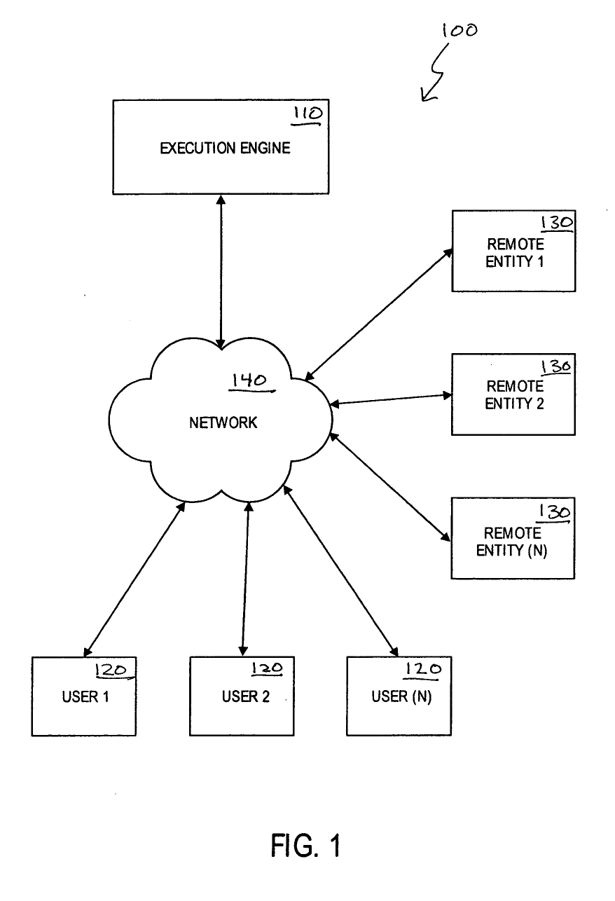

FIG. 1 is a block diagram of one example of a network-based system 100 utilizing an execution engine 110 to remotely execute actions requested by a user. The remotely executed actions are performed transparent to the user and in real-time. The actions are either a transaction or a search. The network-based system 100 includes user devices 120 connected to the execution engine 110 to send executable strings entered by a user to the execution engine 110. The user devices 120 are also connected to the execution engine 110 to receive results from the execution engine 110 once an action has been remotely executed by the execution engine 110. The network-based system 100 also includes remote entities 130 connected to the execution engine 110 to execute actions requested by the execution engine 110 based on information within received executable strings of users. The remote entities are connected to the execution engine 110 so that they can be registered with the execution engine 110 and identified by the execution engine when a user has requested an action to be performed remotely by the execution engine 110. The network 140 is a public network (e.g., the Internet, an accessed local area network (LAN), or a wireless network (WLAN).

The user devices 120 represent devices that allow a user to access data via the network 140. The user devices 120 do not necessarily need to be limited to home computer systems but can be any kind of device capable of communicating over a network such as, but not limited to, personals computers, hand-held device, and mobile phones. The user devices 120 may be connected to the execution engine 110 by a physical connection or by a wireless connection.

The remote entities 130 include a website or a database. In one example the website is an e-commerce website on which a transaction requested by a user or a search requested by a user may be performed remotely by the execution engine 110. Alternatively, the website is a search website that includes a database storing information to provide search results. The remote entities 130 are registered with the execution engine 110. The registration of the remote entities 130 is to create an interface between the remote entities 130 and the execution engine 110.

The execution engine 110 is on a server and is accessed by a user through a website. The website of the execution engine provides the user with user interface including a request box within which the user enters a natural language executable string. A user interface will also be provided offering the user results of the remotely executed action and options relating to the results.

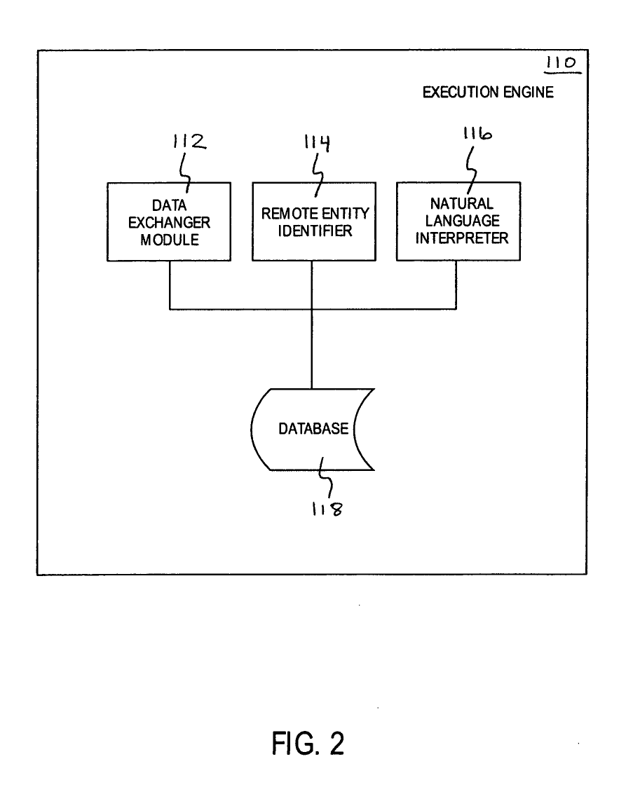

FIG. 2 is a block diagram of the execution engine 110 that includes a data exchanger module 112, a remote entity identifier 114, a natural language interpreter 116, and a database 118. The data exchanger module 112 is responsible for receiving and processing a request for an action submitted by a user from a user device 120 and is responsible for sending a response to a user. The remote entity identifier 114 is responsible for identifying a remote entity as a registered remote entity that is registered with the execution engine 110 as part of the network of remote entities with which a remote action may be executed. The natural language interpreter 116 is responsible for interpreting the natural language requests submitted by users to the execution engine 110 to recognize what action the user is asking for in the executable string. The natural language requests are interpreted to determine what type of action is being requested, for example a transaction or a search. The database 118 stores information on registered remote entities so that the remote entity identifier 114 may identify a remote entity as being registered with-the execution engine 110. The database 118 also stores user information. In one example, the user information is information on a registered user that has an account with the execution engine 110. Such information may include a user's preferences, contact information, and the user's history of use of the execution engine. This information on users is also used to remotely execute actions for the users.

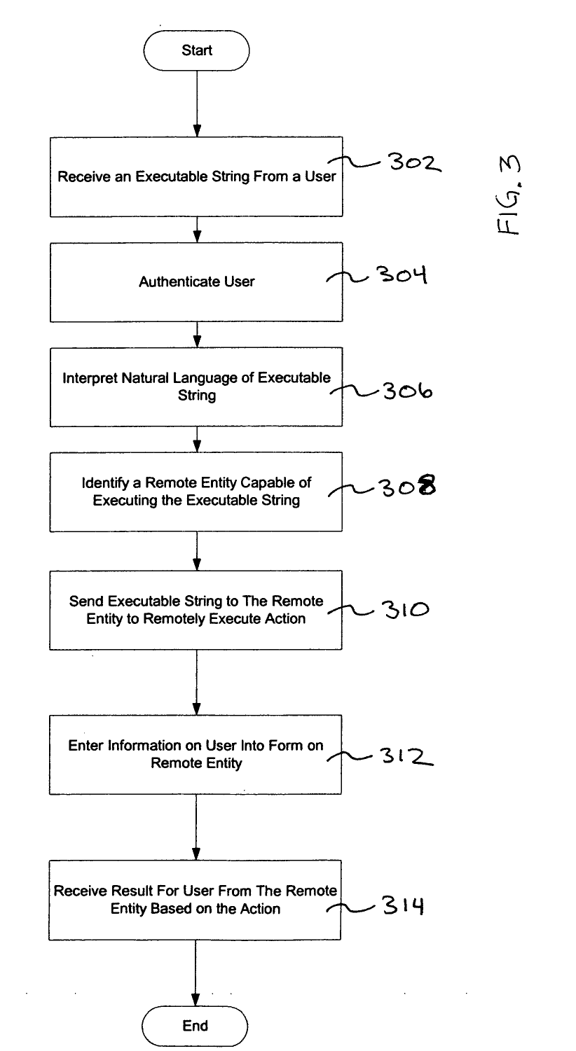

FIG. 3 is a flow diagram of a machine implemented method on the World Wide Web. This method is performed in real-time. In this method, at block 302, the execution engine 110 receives an executable string from a user. This happens by the user entering a natural language sentence into a request box on a user interface of the execution engine 110. The user then sends the natural language sentence to the execution engine 110 as an executable string. The executable string is a request in the form of a query, a transaction entry point, or a combination of a query and a transaction entry point. Different types of queries are recognized, including ranking queries and queries that include more than one parameter but seek a single result.

At block 304 the execution engine authenticates the user. This is performed by determining whether the user has a passport and whether the passport user security identity matches the internet protocol (IP) address or cookie of the passport user computer. A passport is a registration with the execution engine 110. The passport contains information on the user such as the user account, the user IP address or the cookie of the user as well as the personal information of the user such as email address, physical address, phone number, and credit card information. The authentication of the user is performed before sending the executable string to the remote entity 110. Authentication is performed to determine whether a user's information is already stored within the database 118 of the execution engine or if the database 118 has stored a history of the particular user. Authentication is also performed for security reasons to determine whether the user is an impostor.

The execution engine then interprets the natural language of the executable string at block 306 in real-time to determine what action the user is requesting to be performed by the execution engine 110 and thus which types of remote entities 130 the execution engine 110 should contact. The natural language interpreter 116 of the execution engine 110 interprets the natural language of the executable string to determine what type of action is being requested. The natural language interpreter 116 analyzes the natural language executable string to identify terms that would identify the executable string as a request for a transaction or as a request for a search. This is performed by syntactically distinguishing transactions from search queries by noting key words or phrases that are expected to indicate a transaction, a question, or a search.

At block 308 the execution engine 110 identifies a remote entity capable of executing the executable string in real-time. This is performed using the remote entity identifier 114 of the execution engine 110. A remote entity is identified as capable of executing the executable string if the remote entity 130 has an interface to accept the executable string. The remote entities 130 build a local interface to accept the executable string from the search engine and to execute any actions requested. To build the local interface the remote entity 130 registers with the execution engine 110. For any given executable string entered into the execution engine 110 by a user, one or more remote entities are identified. In order for the remote entity to understand and except the executable string entered by a user, the remote entity subscribes to natural language templates for the type of action that can be performed by that remote entity. In the case of an e-commerce website of a remote entity, the e-commerce site would need to understand natural language templates for transactions. When the remote entity is a database or a search engine, then the natural language templates would be for language used when requesting a search.

The user information is then sent in real-time to one or more remote entities 130 at block 310. In an alternate embodiment, the user information is sent to both a crawler generated database and to the remote database at the same time to generate results. The user information is sent as an executable string to remote entities 130 that have been identified as having an interface to accept the executable string and are thus registered with the execution engine. The executable string is sent at block 310 to the remote entity 130 or entities to remotely execute the action requested by the user. The executable string is either a query or a transaction entry point. The transaction entry point is either a request for a purchase or a reservation, or possibly both a purchase and a reservation. Alternatively, the executable string is a combination of a query and a transaction entry point.

At block 312, the executable string is used to enter user information into a form on the remote entity 130 or on a crawler generated database. The information used to fill the form is obtained from the executable string itself and additional information can come from information on the user saved in the execution engine database. The saved user information in the database is either from the information entered by the user when registering a passport with the execution engine or from the user's history. In one instance, the form on the remote entity 130 is a search form to perform a search for a user. In one specific embodiment, the search on the remote entity 130 is to find a product that the user wishes to purchase. The search or transaction requested by the user may have many parameters, requiring the execution engine 110 to fill in more than one form on a single remote entity 130 or forms on more than one remote entity 130. In another example, the form is filled with personal information on the user to conduct a transaction. The transaction is either a purchase or a reservation.

At block 314, after the execution engine 110 has remotely executed an action on a remote entity 130 or the crawler generated database, the execution engine receives a result for the user from the remote entity or the crawler generated database, or both the remote entity database and the crawler generated database. Examples of the result presented to the user include a menu with options to execute on the websites of different remote entities, a confirmation that the action was performed, a query, or a query with an option for remote execution of an action. The result presented to the user may be a request for the user to give a final confirmation to commit to the action. In another example, the results come from more than one remote entity. When the results come from more than one remote entity the results can be ranked based on the number of times that users have selected each of the websites. This helps to eliminate the selection of websites that are registered but do not actually sell anything or are not capable of performing a search.

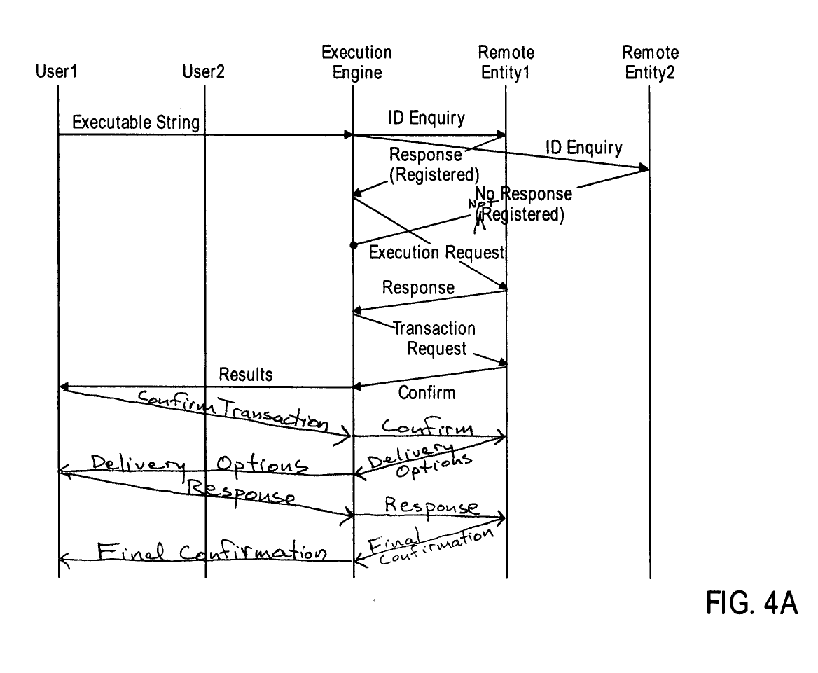

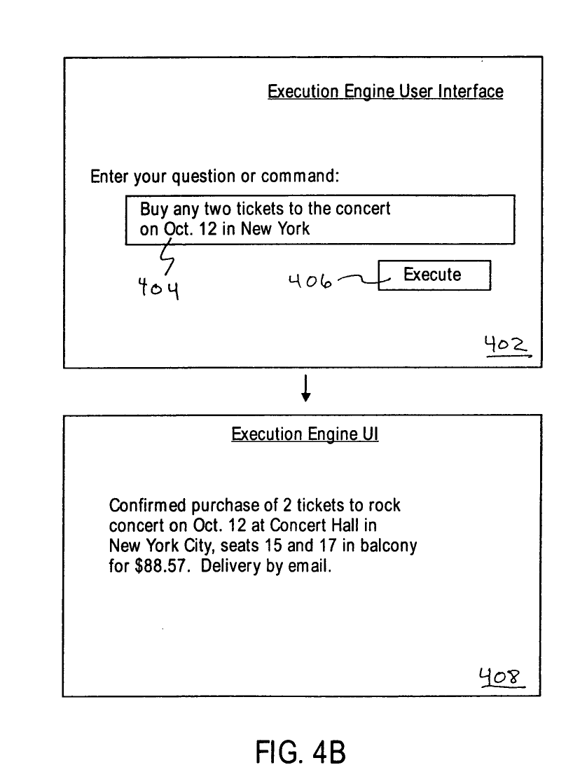

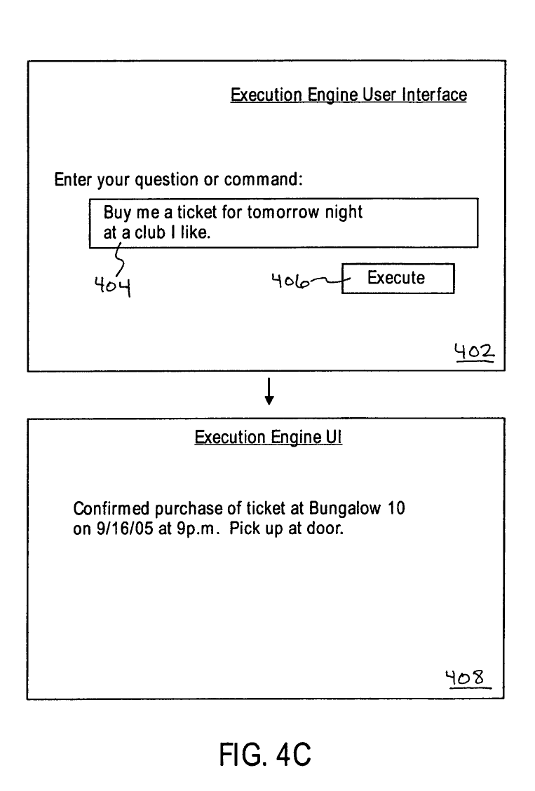

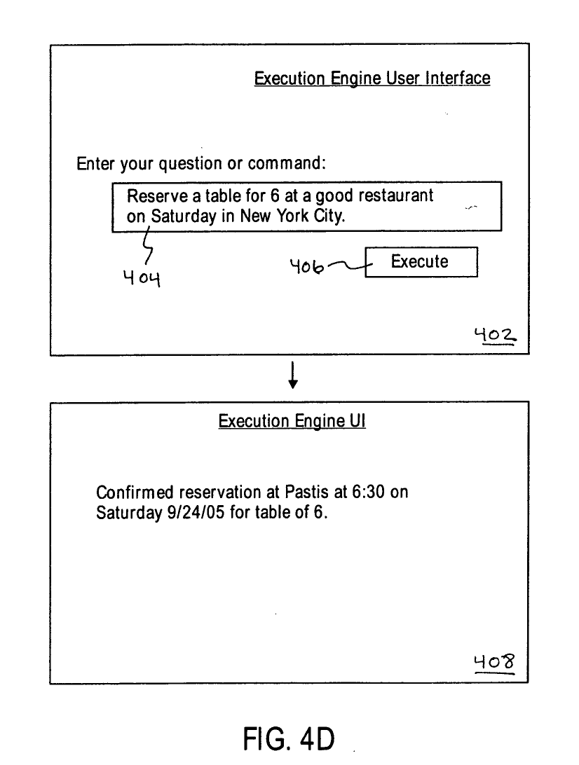

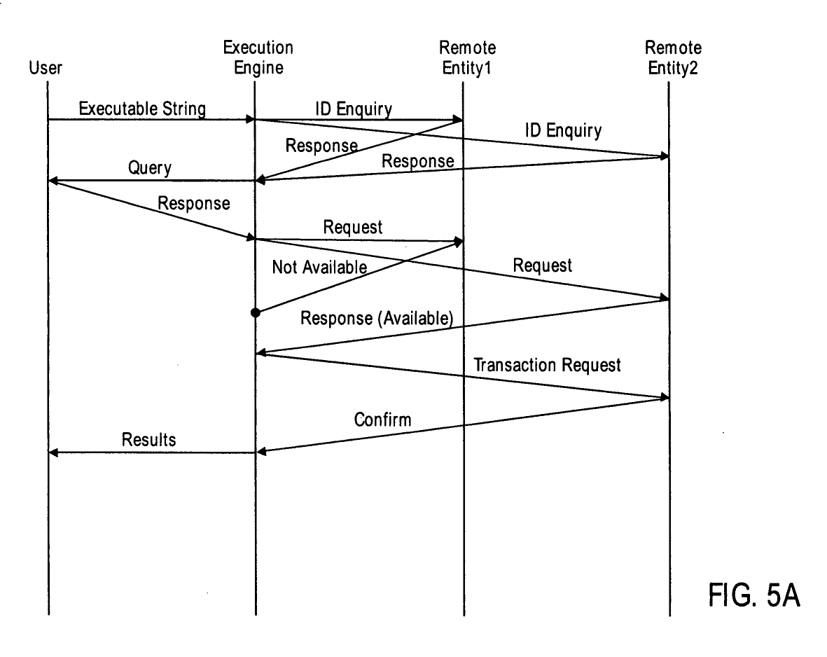

FIGS. 4A-8B illustrate different examples of the method described above. FIG. 4A illustrates an example of a method of an execution engine remotely executing an action on a remote entity. The remote execution of the action is performed transparent to the user. In this example the entire action is performed transparent to the user and the results of the action are presented to the user after the remote execution of the action. In this example the User 1 enters an executable string into the entry box of the execution engine 110. The execution engine then sends out identification enquiries to remote entity 1 and remote entity 2. Remote entity 1 is registered and responds to the execution engine 110. Remote entity 2 is not registered and does not respond to the execution engine 110. The execution engine then sends an execution request to the remote entity 1 in the form of the executable string entered by the User 1.

The remote entity 1 then sends a response to the execution engine requesting information to complete the transaction or to perform the search requested by the user in the executable string. The information requested by the remote entity 1 is the entry of information into a form. In this example the execution engine provides the remote entity 1 with the transaction information needed to perform the transaction by filling in the required fields of a form presented to the execution engine 110. The remote entity 1 then either confirms the completion of the transaction or asks for a confirmation to perform the transaction. The execution engine 110 sends these results to the user. In the instance where the results are a request for a confirmation to perform the transaction the user confirms the charge of the transaction to a credit card. The credit card information is either entered by the user or stored by the execution engine in the user's passport data. In the illustrated example the execution engine 110 passes the user's confirmation onto the remote entity 1. In response, the remote entity 1 sends delivery options to the execution engine. The delivery options are passed on the user 1. Once the user selects a delivery option and responds to the execution engine 110, the execution engine 110 sends the response on to the remote entity 1. Alternatively, the execution engine 110 performs the selection of the delivery options transparent to the user when the user has pre-selected a preferred method of delivery that is stored in the database of the execution engine. The remote entity 1 then sends a final confirmation of the transaction to the execution engine. The final confirmation is then sent to the user for presentation on the user interface of the execution engine 110. Alternatively, the final confirmation is sent to the user's email account.

FIG. 4B illustrates one specific example of the user interface screens seen by the User 1 of a transaction illustrated in FIG. 4A described above. The execution engine 110 user interface seen by the User 1 allows the User 1 to enter an executable string in a natural language sentence into the box 404. The User 1 requests the execution engine 110 to “Buy any two tickets to the concert on October 12 in New York.” The User 1 then clicks on the Execute button 406 to start the method presented in FIG. 4A. In this specific example the entire transaction is performed transparent to the user and the next user interface screen 408 presented to the user by the execution engine 110 confirms the purchase of two tickets to the rock concert on October 12 at Concert Hall in New York City, the seat information, the amount billed to the user's credit card, and the delivery information. This completely transparent transaction is performed based on extensive user passport information saved by the execution engine within a database. The user would have specified in the stored data that such a completely transparent transaction is preferred and that it is acceptable to charge the user's credit card and to deliver the purchased item (in this case tickets) by a preferred method.

FIG. 4C is an example of a transaction performed transparent to the user based on user preferences stored in the database of the execution engine. The user preferences are based on information entered by the user or by information on the user's history. Into the request box 404 of the user interface 402 of the execution engine 110 the user entered the natural language executable string “buy me a ticket for tomorrow night at a club I like.” The user then clicks on the execute button 406 to begin the transaction. In this particular example, the execution engine must first determine which clubs the user likes. For this the execution engine reviews information stored in the database, either the user's history or pre-entered preferences, to determine which remote entities to contact. The execution engine then identifies the appropriate remote entities and sends the executable string requesting tickets for tomorrow night. The transaction is then performed transparent to the user and the next user interface the user sees on the execution engine is the confirmation page 408 confirming the purchase of a ticket at a club that the execution engine knows the user likes.

FIG. 4D illustrates an example of the method illustrated in FIG. 4A where the execution engine makes a reservation for the user based on user preferences or information available on the internet about where to make the reservation. The command entered by the user into the request box 404 of the user interface screen of the execution engine 110 is to “Reserve a table for 6 at a good restaurant on Saturday in NYC.” To execute this request the execution engine must determine a “good restaurant” and must assume that Saturday is the next Saturday on the calendar. To determine a good restaurant the execution engine may query a remote entity's website that ranks or rates restaurants. Alternatively the user may have stored preferences for restaurants or have a history of restaurants that the user likes. The execution engine may respond to the user with a query about which type of restaurant is preferred, which Saturday the user means, or in which neighborhood the user would like to eat. But, if the user prefers minimal interaction with the execution engine and just wants a result, then the execution engine will perform a transaction like the one illustrated in FIG. 4A and return a confirmed result on a confirmation screen 408 of the execution engine.

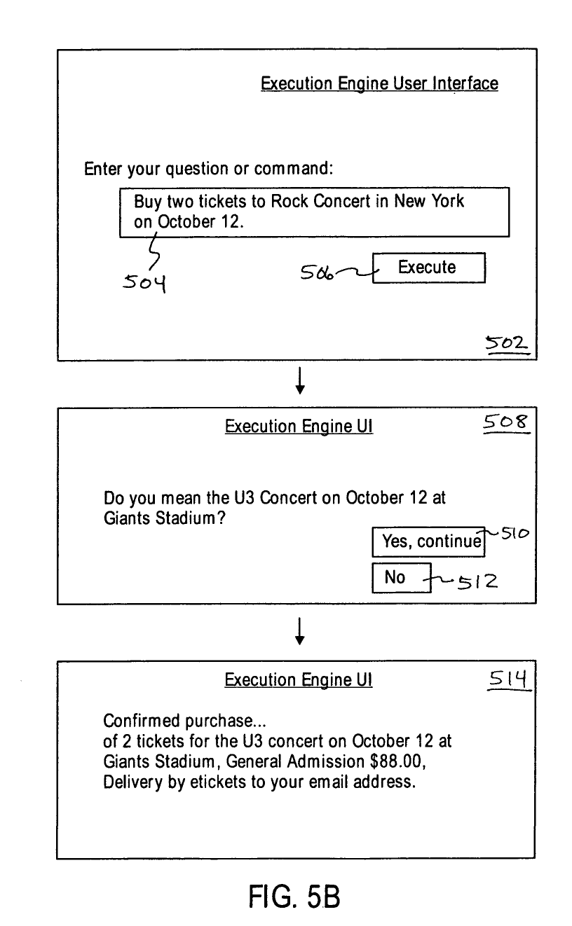

FIG. 5A illustrates an example of a method of an execution engine remotely executing an action on a remote entity and responding with a query and a result. First, the execution engine receives an executable string from the user in the form of a natural language sentence. The execution engine 110 then identifies remote entities 130 that are registered with the execution engine 110 and are capable of reading a natural language executable string. The remote entities 130 selected by the execution engine are e-commerce or search sites that are capable of providing results related to the request entered by the user. Remote entity 1 and Remote entity 2 are both registered with the execution engine 110 and are capable of reading a natural language executable string and thus each send a response to the execution engine 110 related to the natural language request. The execution engine then sends a query to the user to confirm that the result offered by remote entities 130 are what the user desires. The user then confirms that the result is what is desired and the execution engine sends the request to the remote entities 1 and 2. Remote entity 1 then responds that the product or result requested is not available. Remote entity 2 responds that the product or result requested is available. The execution engine then sends a transaction request to the remote entity 2 to complete the transaction. The information on the user needed to complete the transaction is available from the executable string and from the database 118 of the execution engine 110. Once complete, the remote entity 2 returns a confirmation to the execution engine. The confirmation of the transaction is then passed on to the user in the form of a result. Similar to the method illustrated in FIG. 4A, most of the actions performed remotely by the execution engine are transparent to the user.

FIG. 5B illustrates a specific example of the method illustrated in FIG. 5A from the perspective of the user interface presented to the user. The user enters a natural language request into the request box 504 of the user interface 502. The request is to “Buy two ticket to the rock concert in New York on October 12.” The user submits this request to the execution engine by clicking on the execute button 506. The request is then received by the execution engine as a natural language executable string. After identifying appropriate remote entities that are capable of executing the request of two tickets on October 12, the execution engine sends a query. to the user to determine whether the U3 concert on October 12 at Giants Stadium is what the user meant by their request. The user then has the choice of clicking on a button 510 to indicate that it is the correct concert and to continue, or clicking on a button 512 to indicate that it is the wrong concert. If it is the wrong concert the execution engine can offer the user interface 502 to allow the user to resubmit a request. If it is the correct concert, which in this example it is, the user clicks on the “yes, continue” button 510 and the execution engine executes the transaction of purchasing the tickets remotely and transparent to the user. The next user interface 514 presented to the user is a confirmation of the transaction. In this example the transaction was completed and the information presented to the user in user interface 514 is information on the type of tickets, the price, and the delivery. In an alternate example the confirmation presented to the user may require the user to submit a confirmation to the execution engine to charge the cost of the tickets to a credit card and to specify the delivery of the tickets.

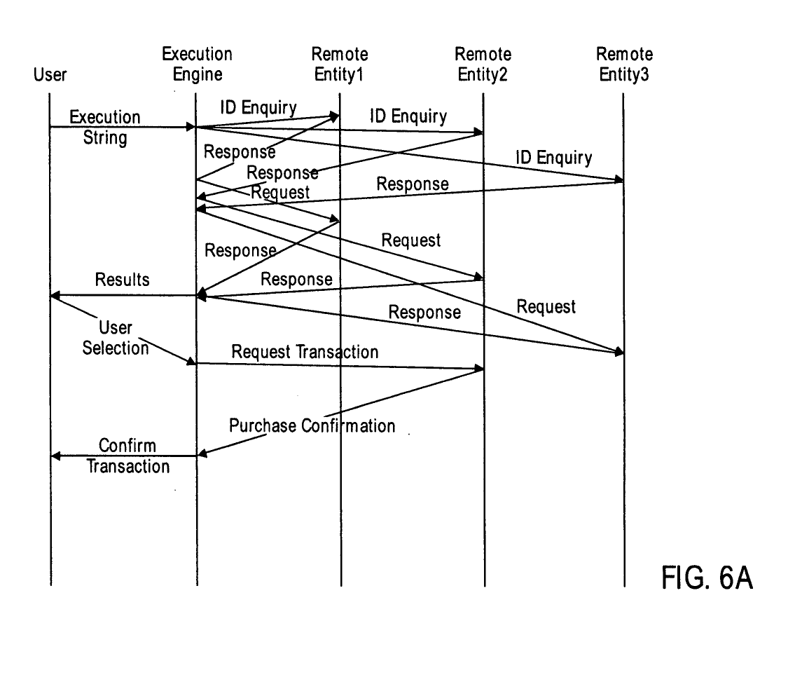

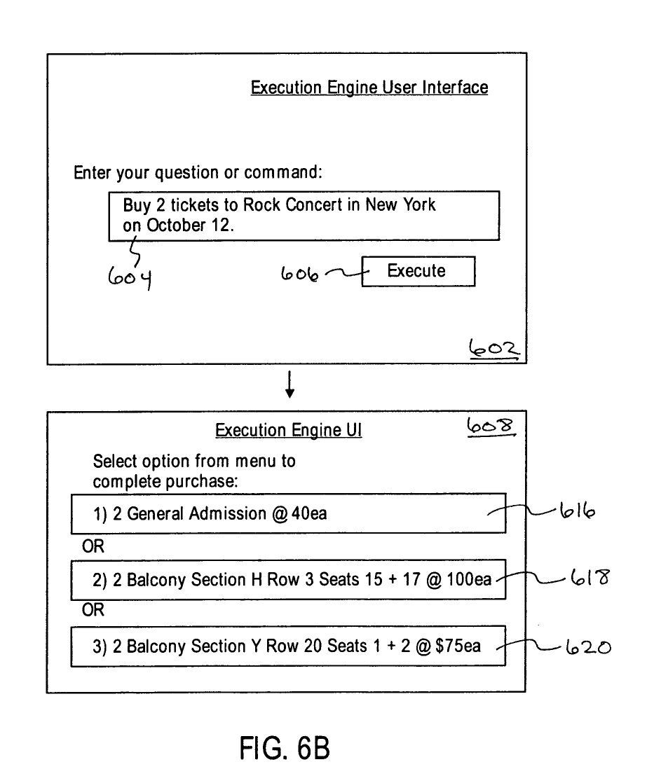

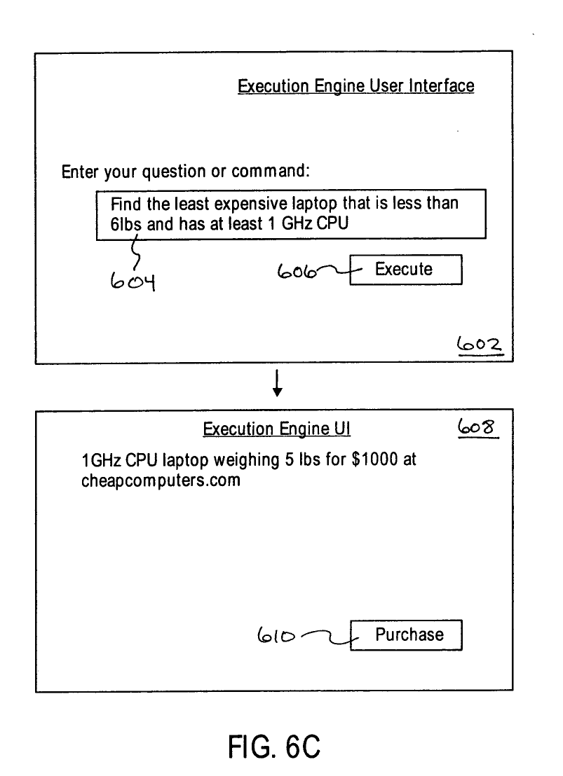

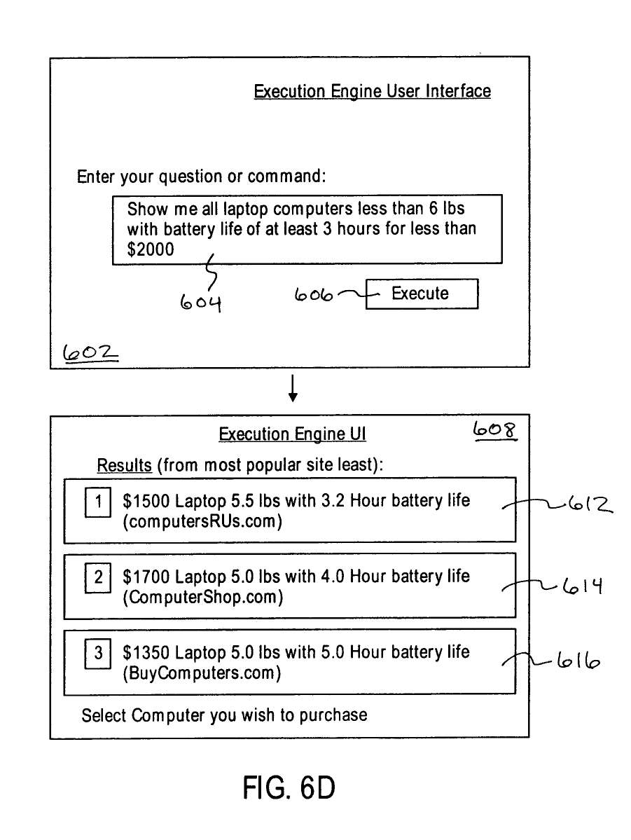

FIG. 6A illustrates an example of a method of remotely executing a transaction or a search where the results presented to the user include either a menu of results from multiple remote entities or a single result sorted by the execution engine from many results from multiple remote entities. First, an executable string is received by the execution engine from the user. The execution engine then determines the appropriate remote entities for the particular request by the user and identifies the remote entities by determining whether they are registered with the execution engine and whether they can accept and read natural language executable strings. In this example three remote entities receive identity (ID) enquiries from the execution engine 110. Each of the remote entities respond that they are registered. The execution engine then sends the user's request to each of the remote entities in the form of a natural language executable string. The execution engine receives responses from each of the remote entities and then either presents a menu of options from the different remote entities to the user or presents a single result selected by the execution engine. The user then selects an option that is communicated with the execution engine 110. The execution engine then requests a transaction based on the result selected by the user. In this instance the execution engine 110 requests the transaction from remote entity 2. The information needed to complete the transaction is provided from the executable string or from the database 118 of the execution engine 110. A purchase confirmation is then sent to the execution engine from the remote entity 2. The execution engine sends a confirmation of the transaction to the user.

FIGS. 6B-6D illustrate specific examples of the method described in FIG. 6A. In FIG. 6B the user enters a request into the request box 604 on the user interface 602 for the execution engine to “buy 2 tickets to the rock concert in New York on October 12.” The request is submitted to the execution engine as a natural language executable string once the user clicks on the execute button 606. As illustrated in FIG. 6A, the execution engine 110 then identifies three remote entities and sends the natural language executable string to each of the three remote entities. Each of the three remote entities responds to the transaction request of the execution engine with an option for tickets to the specified concert. The execution engine then presents the three different options to the user on the user interface screen 608 as a menu from which the user selects one of the ticket purchase options. The user then selects one of the ticket options and the execution engine will execute the remote transaction with the remote entity that provided that option and return a confirmation to the user that the tickets were purchased.

FIG. 6C illustrates an example where the user requests the execution engine to find a product having more than one limiting parameter. The user types in the request “Find the least expensive laptop that is less than 6 lbs and has at least 1 GHz CPU” into the request box 604 of the user interface 602 of the execution engine 110. In this request the user specifies three different limiting factors: least expensive, less than 6 lbs, and at least 1 GHz CPU. The user submits the request to the execution engine 110 by clicking on the execute button 606. The execution engine then identifies registered remote entities and sends the natural language executable string to the three remote entities identified. The execution engine then performs a series of searches on each of the remote entities to find the laptop that fits all of the criteria indicated by the user as the three limiting parameters. These searches are performed transparent to the user and are performed using the information in the executable string. Once the execution engine finds the least expensive laptop computer under 6 lbs and has at least 1 GHz CPU among the different remote entities the execution engine 110 will present the result shown in the user interface 608 to the user. The result is a 1 GHz CPU laptop weighing 5 lbs for $1000 at cheapcomputers.com. The user is given the option to purchase this computer by clicking on the purchase button 610.

FIG. 6D illustrates an example where the user requests a search for all laptop computers weighing less than six pounds with battery life of at least 3 hours for less than $2000. In this example the execution engine 110 will provide the user with a menu of results from which the user may purchase one of the options on the menu. The execution engine goes through a similar process as described above in relation to FIG. 6A and 6B only the results are a menu in response to a search request with multiple limiting parameters. In this example the execution engine does all of the searching and sorting transparent to the user, thereby saving the user a great deal of time and effort.

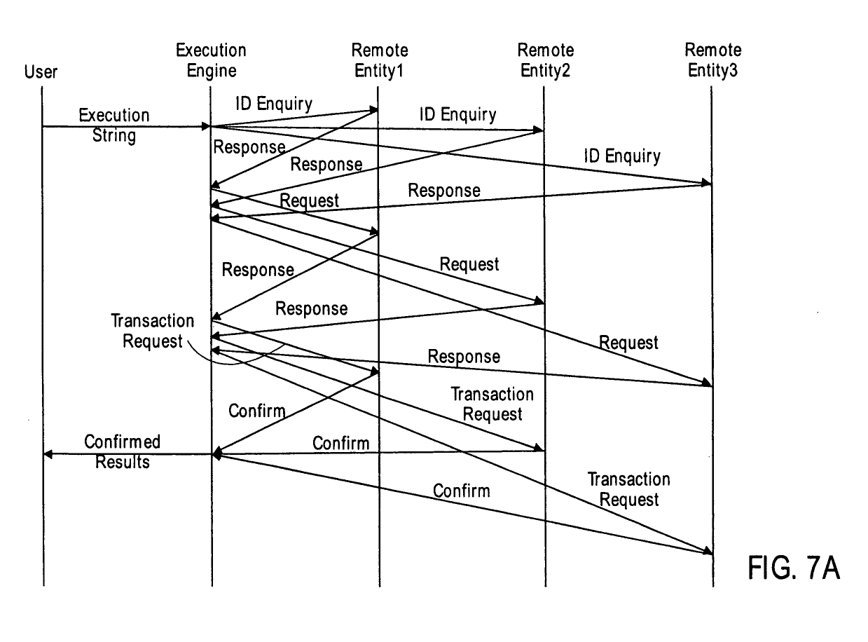

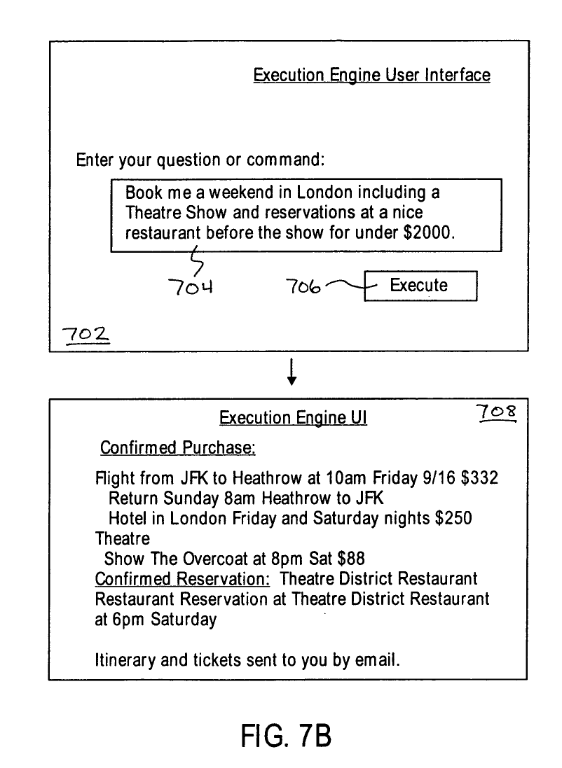

FIG. 7A illustrates an example of a complex user request where the execution engine obtains results from multiple remote entities and performs multiple transactions. In this example, the execution engine acts as a travel agent. FIG. 7B illustrates the user interface 702 where the user enters a request in the request box 704 as a natural language sentence. The user requests the execution engine to “Book me a weekend in London including a theatre show and reservation at a nice restaurant before the show for under $1000” and sends this request to the execution engine as an executable string by clicking on the execute button 706. The execution engine 110 then identifies relevant registered remote entities that are capable of reading a natural language executable string by sending out an identification (ID) enquiry. After the remote entities respond and are determined to be registered the execution engine sends a request for one or more of the user's requested actions and receives a response. The execution engine then sorts the responses from the remote entities and makes sure that all of the limiting parameters of the user's request have been met. The execution engine may then ask the user to confirm the transaction and provide credit card information or approval to charge a stored credit card number. Alternatively, the execution engine may perform the transaction transparent to the user if pre-approved by the user to do so. A transaction request is then sent to each of the remote entities to complete the transactions. The remote entities send confirmations back to the execution engine and the confirmations are presented to the user as confirmed results on the user interface 708.

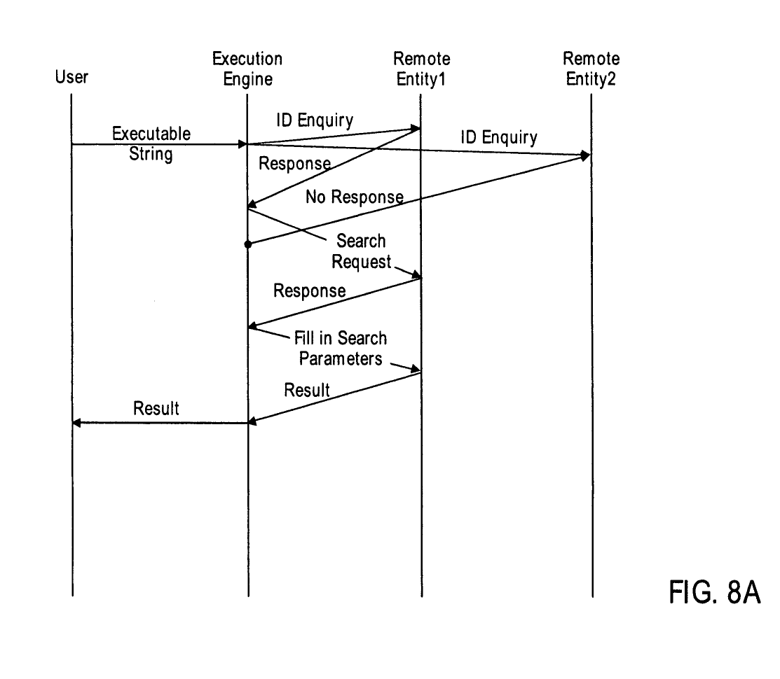

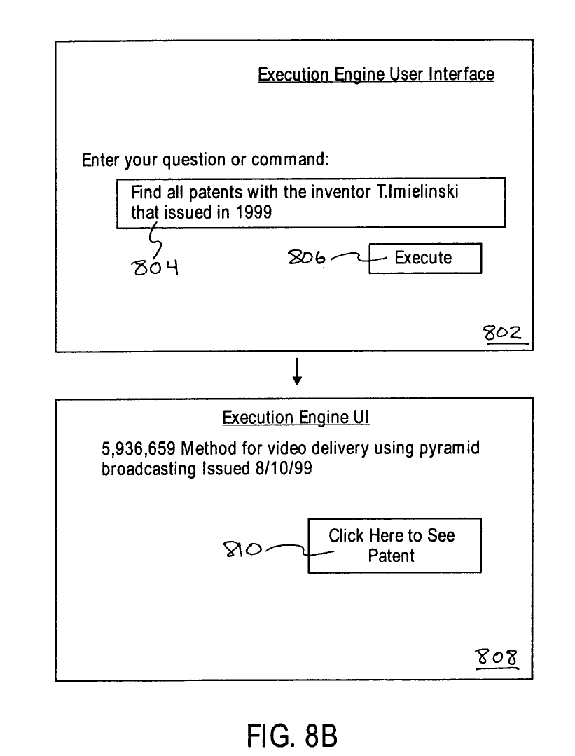

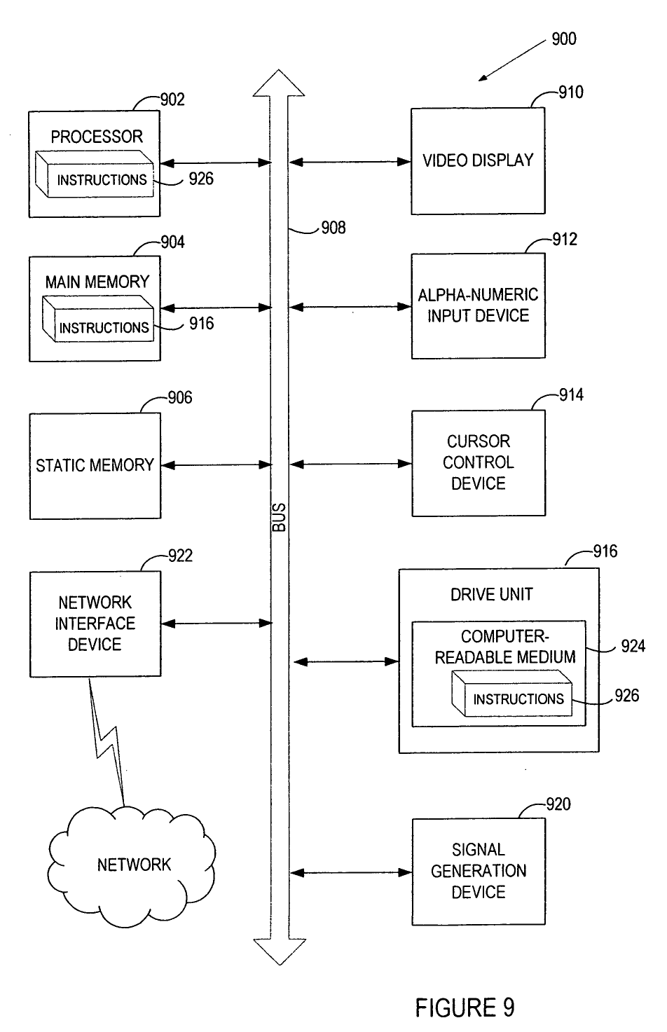

FIGS. 8A and 8B illustrate a example where an execution engine searches a remote entity database or website directly in response to a user request for a search. In this example the user enters the search request into the search box 804 of the user interface 802 of the execution engine 110, as illustrated in FIG. 8B. The user enters the natural language sentence “Find all patents with the inventor T. Imielinski that issued in 1999.” The user clicks on the execute button 806 to send the request to the execution engine to execute the search. The execution engine receives the request as a natural language executable string in FIG. 8A. The execution engine 110 then identifies registered remote entities that could be used to perform the search. The remote entity 1 is registered and responds to the ID enquiry by the execution engine 110. The remote entity 2 does not respond to the ID enquiry and is thus not registered. The execution engine 110 then sends a search request to remote entity 1 to determine whether the search can be performed on the remote entity. The remote entity 1 responds that a search can be performed and the execution engine will fill in the search parameters by filling in a form on the website of the remote entity 1. A search is then conducted by the remote entity 1 and a result is sent to the execution engine. The result is then sent to the user by the execution engine as illustrated by the user interface 808 of the execution engine. Furthermore, the user is given the option to view the patent by clicking on the button 810. In this example the search was performed transparent to the user.

FIG. 9 shows a diagrammatic representation of machine in the exemplary form of a computer system 900 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 900 includes a processor 902, a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 920 (e.g., a speaker) and a network interface device 922.

The disk drive unit 916 includes a computer-readable medium 924 on which is stored a set of instructions (i.e., software) 926 embodying any one, or all, of the methodologies described above. The software 926 is also shown to reside, completely or at least partially, within the main memory 904 and/or within the processor 902. The software 926 may further be transmitted or received via the network interface device 922. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Thus, a method and apparatus for the remote execution of actions transparent to a user at a registered remote entity in real-time has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

We claim:

1. A machine implemented method for performing a search on the World Wide Web, comprising:
receiving an executable string from a user;
identifying a remote entity capable of executing the executable string;
sending the executable string to the remote entity to remotely execute an action using information from the executable string; and
receiving a result for the user from the remote entity based on the action.

2. The machine implemented method of claim 1, wherein the method is performed transparent to the user.

3. The machine implemented method of claim 1, wherein the executable string comprises a natural language executable string.

4. The machine implemented method of claim 3, further comprising interpreting the natural language executable string.

5. The machine implemented method of claim 1, wherein the executable string is a query.

6. The machine implemented method of claim 5, wherein the query is a ranking query.

7. The machine implemented method of claim 5, wherein the query includes more than one parameter and the result is a single result.

8. The machine implemented method of claim 1, wherein the executable string is a transaction entry point.

9. The machine implemented method of claim 1, wherein the executable string is a combination of a query and a transaction entry point.

10. The machine implemented method of claim 1, wherein identifying the remote entity capable of executing the executable string comprises determining whether the remote entity has an interface to accept the executable string.

11. The machine implemented method of claim 1, wherein identifying the remote entity capable of executing the executable string comprises determining whether the remote entity is a remote entity registered to accept the executable string.

12. The machine implemented method of claim 1, further comprising sending the user information to a crawler generated database at the same time that the user information is sent to the remote entity.

13. The machine implemented method of claim 1, further comprising entering user information into a form on the remote entity.

14. The machine implemented method of claim 13, wherein the user information is obtained from stored user information.

15. The machine implemented method of claim 13, wherein the user information is obtained from a user history.

16. The machine implemented method of claim 13, wherein the user information is obtained from the executable string.

17. The machine implemented method of claim 1, wherein the action executed on the remote entity is a transaction.

18. The machine implemented method of claim 17, wherein the transaction is a purchase.

19. The machine implemented method of claim 18, wherein the transaction is a reservation.

20. The machine implemented method of claim 1, wherein the action executed on the remote entity is a search.

21. The machine implemented method of claim 1, wherein the remote entity is a registered ecommerce website.

22. The machine implemented method of claim 1, wherein the remote entity comprises a search engine including a database.

23. The machine implemented method of claim 1, wherein sending the executable string to the remote entity comprises sending the executable string to a plurality of remote entities to receive a result for a user from more than one remote entity.

24. The machine implemented method of claim 23, wherein the result displayed to the user comprises a menu with options for execution of the action on different remote entities.

25. The machine implemented method of claim 1, wherein the result comprises a confirmation that the action was performed.

26. The machine implemented method of claim 1, wherein the result comprises a query.

27. The machine implemented method of claim 1, wherein the result comprises a combination of a query and an option for remote execution of an action.

28. The machine implemented method of claim 1, wherein the result comprises a list of options for remote execution of an action.

29. The machine implemented method of claim 1, wherein the result is a request for the user to give a final confirmation to commit to the action.

30. The machine implemented method of claim 1, further comprising authenticating the user before sending the executable string to the remote entity.

31. The machine implemented method of claim 30, wherein the authentication comprises determining whether the user has a passport and whether the passport user security identity matches the internet protocol (IP) address or cookie of the passport user computer.

32. A system, comprising:
an execution engine to remotely execute actions requested by a user;
a plurality of user devices, the plurality of user devices connected to the execution engine to send executable strings to the execution engine and to receive results from the execution engine; and
a plurality of remote entities, the plurality of remote entities connected to the execution engine to execute actions requested by the execution engine based on information within received executable strings of users.

33. The system of claim 32, wherein the plurality of remote entities include websites.

34. The system of claim 32, wherein the execution engine is on a server.

35. An execution engine, comprising:
a data exchanger module to receive an executable string from a user, to send the executable string to a remote entity, and to receive a result from the remote entity to present to the user; and
a remote entity identifier to identify whether the remote entity has an interface to accept the executable string from the execution engine.

36. The apparatus of claim 35, further comprising a database to store user information and registry information of remote entities.

37. The apparatus of claim 35, further comprising a natural language interpreter to recognize what action the user is asking for in the executable string.

38. A computer-readable medium that provides instructions, which when executed on a processor, causes the processor to perform a method comprising:
receiving an executable string from a user;
identifying a remote entity capable of executing the executable string;
sending the executable string to the remote entity to remotely execute an action using information from the executable string; and
receiving a result for the user from the remote entity based on the action.

39. The computer-readable medium of claim 38, wherein the method further comprises authenticating a user before sending the executable string to the remote entity.

40. The computer-readable medium of claim 38, wherein the method further comprises performing the method transparent to the user.

41. The computer-readable medium of claim 38, wherein the method further comprises entering information on the user into a form on the remote entity.
